(19) United States
(12) Patent Application Publication
(10) Pub. No.: US 2015/0147427 A1
(43) Pub. Date: May 28, 2015

(54) EXTRUSION HEADS

(71) Applicant: Michael Lundwall, Springville, UT (US)

(72) Inventors: Michael Lundwall, Springville, UT (US); Jerome Miles, Spanish Fork, UT (US)

(73) Assignee: Michael Lundwall, Springville, UT (US)

(21) Appl. No.: 14/089,372

(22) Filed: Nov. 25, 2013

(51) Int. Cl. B29C 67/00; B29C 47/08

(52) U.S. Cl. CPC B29C 67/0055; B29C 47/08
USPC 425/375; 425/461; 29/525.11

(57) ABSTRACT

In one example, an extrusion head includes a mounting block, a heater block, and a polymer sleeve extending between the heater block and the mounting block. A fastener connector also connects the heater block to the mounting block, wherein the polymer sleeve and the fastener create a fully constrained connection between the heater block to the mounting block.

### BACKGROUND

Three dimensional printing is an additive manufacturing process that can form virtually any shape of three dimensional objects from a digital model. To accomplish this, the three dimensional printer applies successive layers of materials in different shapes. A three dimensional printer may use a plastic filament or other material that is pushed into an extrusion head. The extrusion head is heated to melt the material and then selectively deposits the material to form the desired object.

Extrusion heads can be complex and expensive. The extrusion head should reliably handle the material over a wide range of conditions and for long periods of time to produce the desired three dimensional objects. The extrusion head should be configured to reliably heat the material to a desired temperature throughout a range of feed rates and with various different materials. Further, the extrusion head should operate without clogging or leaking the melted material. If an extrusion head clogs while printing an object, the geometry of the object may not be accurate or the object may be entirely ruined. Leaking of melted material out of the nozzle can result in contamination and reliability issues. In addition to a design that mitigates these issues, an extrusion head would ideally be designed to be simple, compact, and easily repaired.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a perspective view of a three dimensional printer with a filament extruder, according to one example of principles described herein.

FIGS. 2A, 2B, 2C and 2D are views of an extrusion head, according to one example of principles described herein.

FIGS. 3A and 3B are views of parts in an extrusion head, according to one example of principles described herein.

FIG. 4 is a diagram of thermal paths in an extrusion head, according to one example of principles described herein.

FIG. 5 is a flowchart of a method for assembling extrusion heads, according to one example of principles described herein.

Throughout the drawings, identical reference numbers designate similar, but not necessarily identical, elements.

### DETAILED DESCRIPTION

As discussed above, the extrusion head is heated to melt the printing material and is then moved over the work piece to selectively deposit additional material. The extrusion head should reliably control a variety of printing materials through a range of feed rates without leaking or clogging. For example, an extrusion head may be used to print a variety of materials including a range of acrylonitrile butadiene styrene (ABS) plastics, polylactic acid (PLA) plastics, polyesters, polycarbonates, polyphenylsulfone (PPSF), and a variety of other thermoplastics. These materials each have different melting temperatures and heat capacity. The feed rates for these materials may range during printing from no feed rate to hundreds of millimeters per second. The extrusion head should reliably heat the printing material to the specific temperature at the given feed rate.

In an effort to improve the performance of the extrusion head, a number of manufacturers have created large, complex and expensive extrusion heads. These extrusion heads have a number of disadvantages. A large extrusion head can reduce the total build area in a three dimensional printer and increase the mass that must be controlled during printing. The complexity of the extrusion head can result in difficulty in repair and/or replacement of components of the extrusion head.

The principles described below enable the design and construction of a compact extrusion head with a reduced part count. The extrusion head has increased reliability and allows for easy replacement of the nozzle, which is the most common consumable component in the extrusion head.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples. Features shown and/or described in connection with one figure may be combined with features shown and/or described in connection with other figures. Further, as used in the present specification and in the appended claims, the term “a number of” or similar language is meant to be understood broadly as any positive number comprising 1 to infinity; zero not being a number, but the absence of a number.

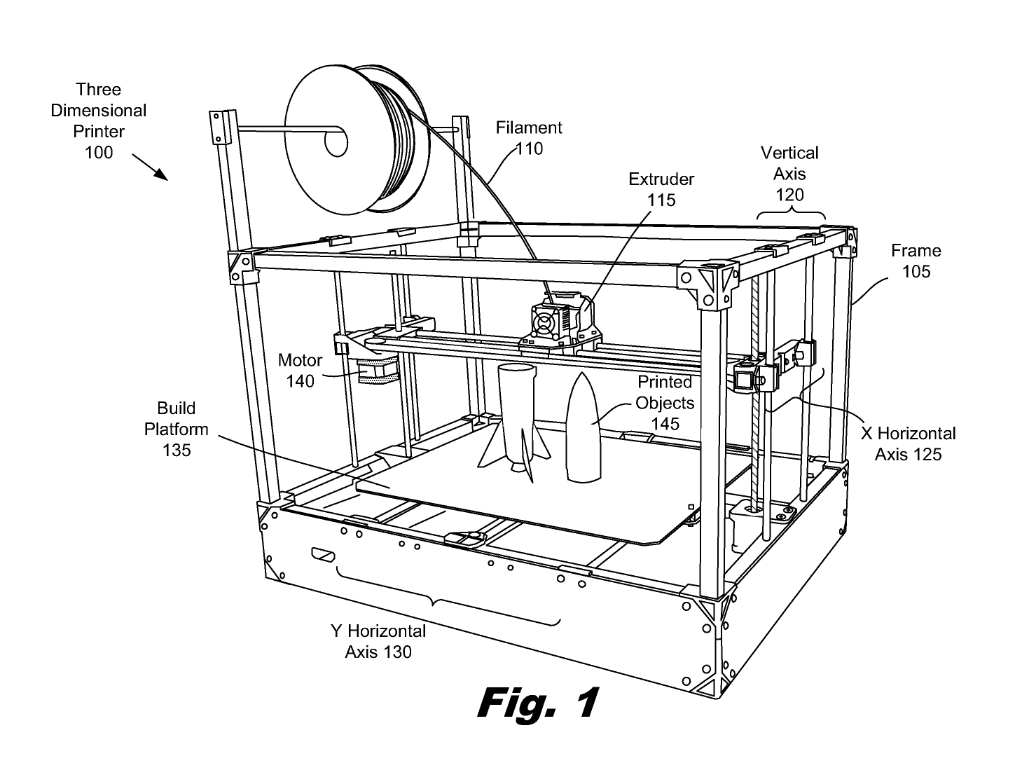

FIG. 1 is a perspective view of a three dimensional printer (100) that includes a frame (105) that supports three motion axes (120, 125, 130). This three dimensional printer includes a filament extruder (115) that is actuated vertically (in the Z direction) by the vertical axis (120) and in the X direction by the X horizontal axis (125) and motor (140). The build platform (135) is actuated in the Y direction by the Y horizontal axis (130). The combination of the three orthogonal axes allows the extruder (115) to move through a three dimensional volume with respect to the build platform (135) to create a variety of printed objects (145). The printing material in this example is a polymer filament (110) that is fed off of a roll into the filament extruder (115). A feed mechanism in the extruder (115) feeds the filament (110) into an extrusion head. The extrusion head melts the filament and dispenses the material to progressively produce the desired object.

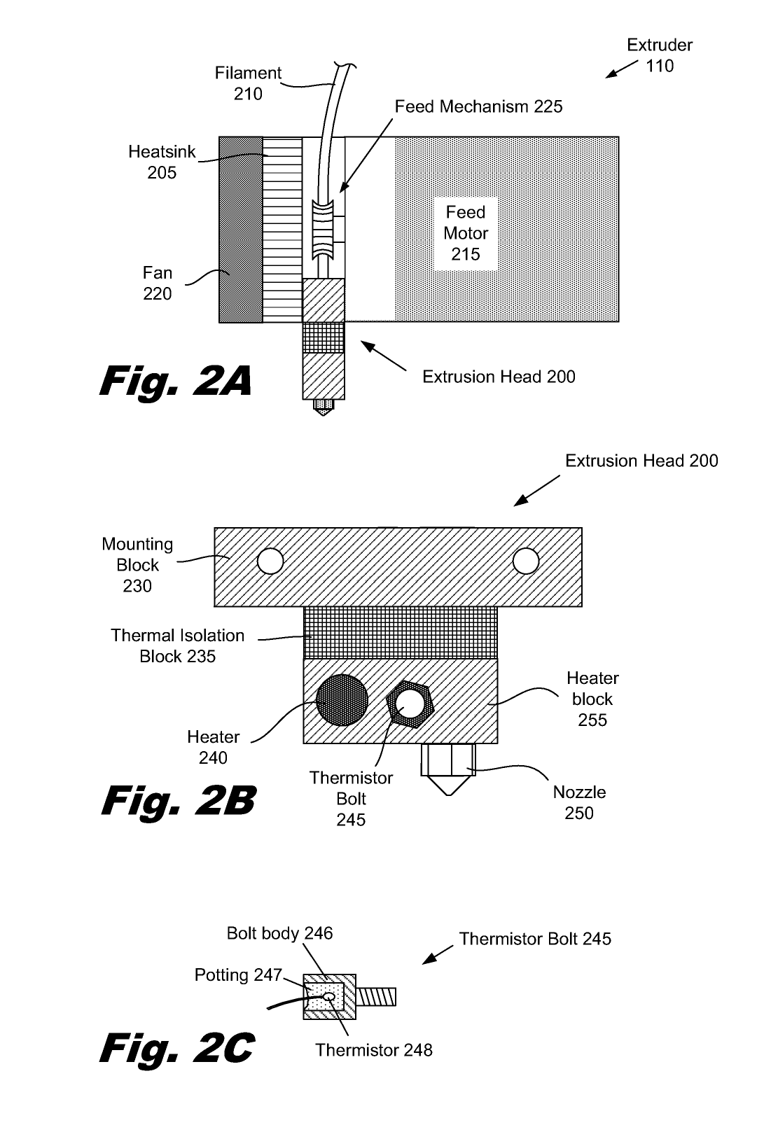

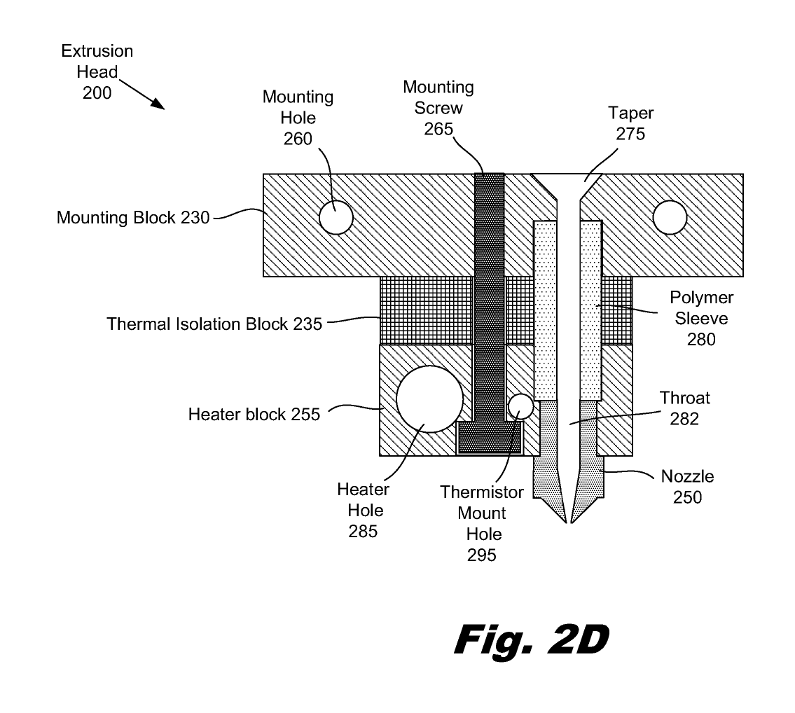

FIG. 2A is a side view of the extruder (110). In this implementation, the extruder (110) includes a feed motor (215) that drives a feed mechanism (225). The feed mechanism (225) may include any of a variety of mechanisms to grip the filament (210) and feed it into the extrusion head (200). In this example, the feed mechanism (225) includes a concave textured drive gear that engages with the filament (210) and drives the filament (210) into the extrusion head (200) as it rotates. The feed mechanism (225) may include a variety of other parts, including a spring mechanism to push the filament (210) into secure contact with the drive gear. A heat sink (205) and fan (220) are connected to the extrusion head (200), feed mechanism (225) and feed motor (215) to dissipate excess heat. Heat can be generated from a variety of sources, including the feed motor, friction, and the heat supplied to the extrusion head to melt the filament. However, in some embodiments, the extruder (110) may not require all the components listed. For example, the heat sink and/or fan may not be required. These components (205, 220) may be included in designs where they are needed for thermal management and left off designs that do not need the heat dissipation.

FIG. 2B is a front view of an extrusion head (200). The extrusion head (200) includes a mounting block (230), a thermal isolation block (235) and a heater block (255). The mounting block (230) serves as an anchor point for the extrusion head (200) and can be used to connect the extrusion head (200) to the feed motor (215, FIG. 2A) and/or heat sink (205, FIG. 2A). In one example, the heater block (255) forms connection points for a heater (240), a thermistor bolt (245), and a nozzle (250). The heater (240) generates heat to melt the filament. For example, the heater may be a cartridge heater.

A nozzle (250) is screwed into the heater block (255). The nozzle (250) conducts heat from the heater block (255) into the filament (210, FIG. 2A) and controls the flow of the filament out of the extrusion head (200). The thermal isolation block (235) is used to thermally separate the heater block (255) from the mounting block (230). This thermal separation serves a number of purposes, including preventing premature melting of the filament (210, FIG. 2A). If an upper portion of the filament (210, FIG. 2A) melts prematurely (before being pushed down into the heater block (255)), the melted material can flow backwards out of the extrusion head (200) and into other areas in the feed mechanism (225, FIG. 2A). Thermally separating the mounting block (230) from the heater block (255) prevents large amounts of heat from flowing from the heater/heater block (240, 255) into the mounting block (230). The heat sink/fan (205, 220; FIG. 2A) is also connected to the mounting block (230) to extract excess heat. This helps the mounting block (230) maintain a temperature that is lower than the melting point of the filament material.

FIG. 2C shows one example of a thermistor bolt (245). The thermistor bolt (245) includes a bolt body (246) with a cavity in the head of the bolt body (246). To form the thermistor bolt (245), a thermistor (248) is potted into a cavity in the head of the bolt. The potting (247) holds the thermistor (248) in place in the cavity and ensures good thermal contact between the thermistor (248) and the bolt body (246). The potting/bolt body (247, 246) also protects the thermistor (248) from damage. The thermistor bolt (245) is then screwed into the heater block (255, FIG. 2B). The thermistor (248) then measures the temperature of the heater block (255, FIG. 2B). The three dimensional printer's control circuitry uses this measurement to control the power supplied to the heater (240) with the goal of maintaining the heater block (255, FIG. 2B) at a constant temperature or within a range of temperatures.

FIG. 2D shows a cross sectional diagram of the extrusion head (200). In this example, the mounting block (230) includes two mounting holes (260). The mounting block holes (260) are used to connect the extrusion head (200) to the feed motor (215, FIG. 2A) and/or heat sink (205, FIG. 2A). In addition, a threaded hole extends through the heater block (255), the thermal isolation block (235) and the mounting block (230) to receive a mounting screw (265). The mounting block (230) also includes a tapered conic hole (275) that guides the filament (210, FIG. 2A) into the throat (282) of the extrusion head (200). In this implementation, a polymer sleeve (280) lines the throat (282) from approximately the mid-point of the mounting block (230) to the mid-point of the heater block (255). The polymer sleeve (280) may be formed from a variety of heat resistant polymers, including polytretrafluoroethylene (PTFE), fluorinated ethylene-propylene (FEP), perflouro-alkoxy polymer (PFA), other polyethylenes, other flouro-polymers, other suitable materials and combinations thereof. The polymer sleeve (280) is typically a thermal insulator and can protect the filament (210, FIG. 2A) from melting until it makes contact with the nozzle (250). When the polymer sleeve (280) is formed from material that flows cold (such as PFTE), it can be advantageous to contain the polymer sleeve (280) around its exterior/perimeter surfaces to prevent undesired deformation of the polymer sleeve (280). In this example, the polymer sleeve (280) is contained around its diameter by the thermal isolation block (235), the heater block (255) and the mounting block (230). In some examples, the polymer sleeve may fit fairly tightly in the holes in the blocks (230, 235, 255). The ends and edges of the polymer sleeve (280) are also contained and protected from direct contact with the filament (210, FIG. 2A). If the filament passed directly into the polymer sleeve, the filament could abrade the edges and upper surface of the polymer sleeve. The polymer sleeve may be selected from polymers that have relatively low coefficients of friction. This reduces the incidence of filament jamming within the polymer sleeve. If melted filament material flows up into the polymer sleeve, it can typically be removed by simply advancing the filament.

FIG. 2D also shows the heater hole (285) and the thermistor mount hole (295) in the heater block (255). The nozzle (250) is threaded into the heater block (225) and can be formed from a variety of conductive materials. For example, the nozzle (250) may be formed from brass. Brass has a number of advantages, such as a relatively high thermal conductivity and low friction.

The thermal isolation block (235) is sandwiched between the heater block (225) and the mounting block (230). The thermal isolation block (235) may be made out of a variety of materials such as polyether ether ketone (PEEK) or other thermally and mechanically stable materials.

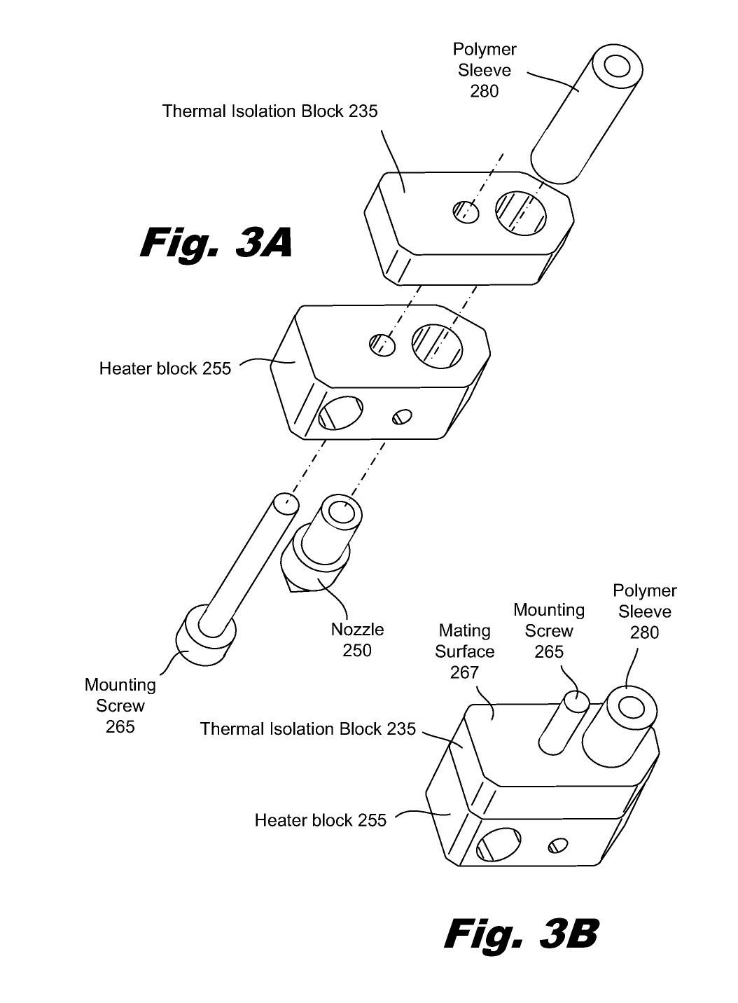

FIG. 3A is an exploded view of the lower portion of the extrusion head (200, FIG. 2B) and shows the relationships between the various components. The nozzle (250) is screwed into the heater block (255) and a mounting screw passes through the through holes in both the heater block (255) and the thermal isolation block (235). The polymer sleeve (280) fits into holes in the thermal isolation block and the heater block. In some examples, the polymer sleeve (280) fits fairly tightly into the blocks due to the friction or light press fit with the holes and the polymer sleeve (280). This has the effect of slightly compressing the polymer sleeve (280).

One common task in a three dimensional printer is to replace the nozzle (250). The nozzle (250) may need to be replaced for a variety of reasons, including wear, contact damage, to clear a jam/clogging, or a desire to change out the nozzle for a nozzle with a different orifice size. To easily replace a nozzle (250), the heater block (255) or other structure supporting the nozzle (250) should be secured so that it does not rotate or move while the nozzle (255) is being unscrewed. This allows the nozzle (250) to be replaced simply by lifting the extruder (115, FIG. 1) using Z axis mechanism (120, FIG. 1), unscrewing the nozzle (250), and then screwing in the new nozzle (250).

However, in contemporary designs, the heater block (or equivalent structure) is not secured so that it does not spin when torque is applied to the nozzle. In these situations, the entire extrusion head must be removed to replace the nozzle. The heater block can then be held while the nozzle is removed. However, this is inconvenient and can result in damage to wires and to other components.

In the implementation shown in FIG. 3B, the heater block (255) (and thermal isolation block (235)) is secured to the mounting block (230, FIG. 2D) by a “pin and bolt” arrangement that prevents undesirable rotation of the heater block (255) while the nozzle (250, FIG. 2D) is removed. The polymer sleeve (280) serves as the “pin” by extending upward into the mounting block (see FIG. 2D). The mounting screw (265) is also connected through the heater block/thermal isolation block (255, 235) and screwed into the mounting block (230, FIG. 2D) to mate the mating surface (267) with a lower surface of the mounting block (230, FIG. 2D). This secures the heater block (255) from rotation and translation with respect to the mounting block (230, FIG. 2D) and maintains the desired level of thermal isolation between the heater block and the mounting block.

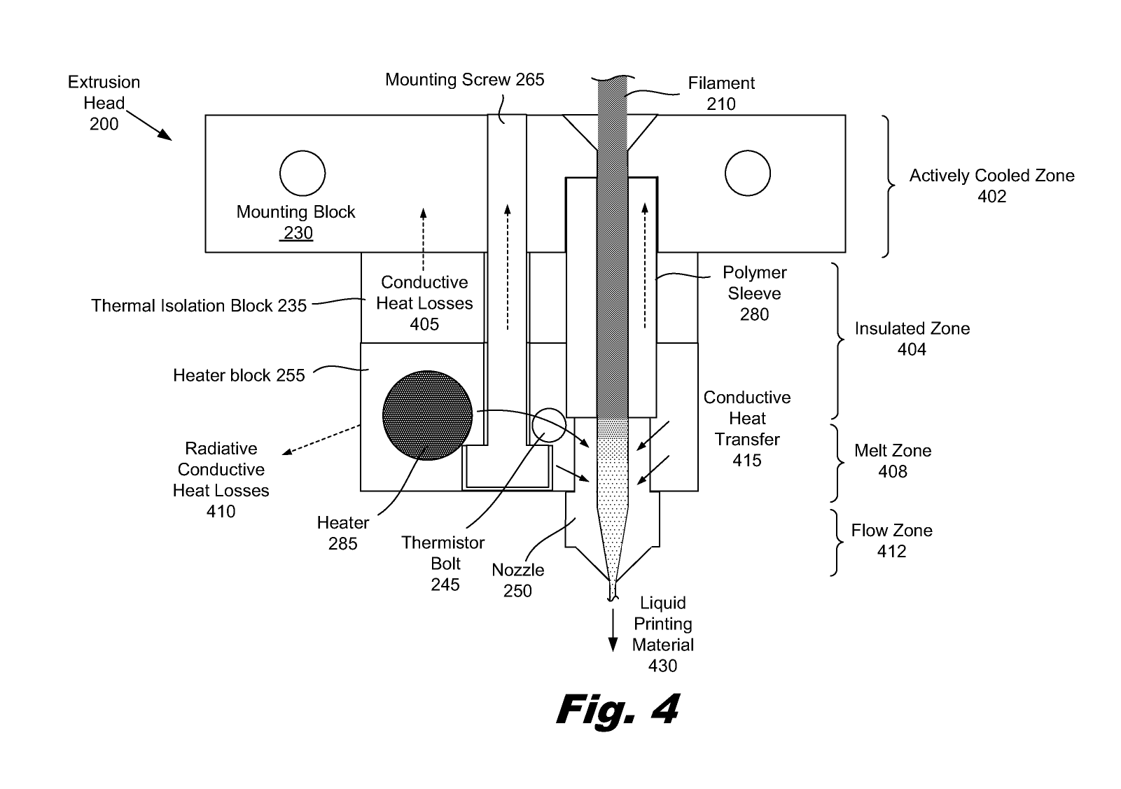

FIG. 4 shows a cross sectional diagram of an extrusion head (200) with various heat paths illustrated as arrows. It is desirable for the heat produced by the heater (285) to be conducted into the heater block (255), through the nozzle (250) and into the filament (210) passing through the nozzle (250). Alternative heat paths (405, 410) represent heat loss that can be minimized and/or compensated for. For example, there are number of conductive heat losses (405) shown by dotted arrows pointing vertically upward from the heater block (255) to the mounting block (230). These conductive heat losses (405) represent heat that flows through the thermal isolation block (235), the mounting screw (265) and the polymer sleeve (280). These losses are minimized by selecting materials that have a relatively low thermal conductivity and/or small cross section.

For example, the thermal isolation block (235) and polymer sleeve (280) may be formed from materials that have the desired mechanical characteristics and also have a low thermal conduction. The thermal isolation block (235) may have the same or different cross sectional shape/dimensions as the heater block (255). As shown in the embodiment of FIGS. 3A and 3B, the thermal isolation block (235) may have a planar shape that is the same as the heater block (255). The mounting screw (265) may have a higher thermal conduction but have a relatively small cross section. In other examples, the thermal isolation block (235) may have a cross sectional area that is smaller than the heater block (255) to further limit the flow of heat. In some implementations, the mounting screw (265) may be formed from stainless steel, which has a much lower thermal conduction than other metals. Additional losses are radiative and conductive heat losses (410) into the surroundings, also shown by a dotted arrow.

This configuration of the extrusion head (200) creates a number of thermal zones: an actively cooled zone (402), an insulated zone (404), a melt zone (408) and a flow zone (412). These zones control the temperature of the filament (210) for improved performance and reduction of clogging and leakage. The actively cooled zone (402) is in the mounting block (230), which is actively cooled by the heat sink and fan (205, 220; FIG. 2A). In this zone, the filament (210) is at or slightly above room temperature. The filament (210) retains its structural properties and is pushed into the polymer sleeve (280) by the feed mechanism (225, FIG. 2A).

The insulated zone (404) occurs where the filament (210) is passing through the polymer sleeve (280). The temperature of the filament (210) may increase, but the filament (210) does not melt. As the filament (210) exits the sleeve/insulating zone (404), it contacts the hot walls of the nozzle (250) and rapidly melts in the melt zone (412). The temperatures of the nozzle (250), heater block (255), and thermistor bolt (245) are approximately equal due to their high thermal conductivity and direct mechanical contact. This allows the control circuitry in the three dimensional printer (100, FIG. 1) to use the readings from the thermistor (248, FIG. 2C) to control the output of the heater (285) and temperature of the nozzle (250). The temperature set point of the heater block (255) can be adjusted according to any of a number of factors, including the type of filament material and the feed rate of the material into the nozzle (250). As the filament material melts, it enters the flow zone (412). The flow zone (412) is a progressively narrowing portion of the throat (282, FIG. 2D) that terminates in an orifice through which the liquid printing material (430) exits. The orifice may be significantly smaller than the diameter of the filament.

The examples given above are only illustrative of principles described herein. The principles can be used to form a wide range of extruders and extrusion heads with different geometries and components. In general, an extrusion head includes a mounting block, a heater block, and a heat resistant polymer sleeve extending between the heater block and the mounting block. A fastener also connects the heater block to the mounting block such that the polymer sleeve and the fastener create a fully constrained connection between the heater block to the mounting block. A fully constrained connection refers to a connection wherein no translational or rotational degrees of freedom are present between the two connected parts without plastic deformation of one of the components. For example, a pin and an offset fastener that bring two objects together creates a fully constrained connection between the two planar objects when the pin and offset fastener join a planar surface on a first object with a mating planar surface on the second object. An intervening planar component (such as the thermal isolating block) does not disrupt the fully constrained connection if the fasteners pass through the intervening planar component. The connection does not exhibit X, Y, Z translation or rotations about the X, Y, or Z axes between the joined components. For example, the fastener and the polymer sleeve may be parallel and offset to form a pin and fastener connection that prevents rotation of the heater block with respect to the mounting block such that the nozzle can be unthreaded from the heater block without the heater block rotating with respect to the mounting block.

As discussed above, the exterior surface of the polymer sleeve may be entirely enclosed by the surrounding structure (the blocks and the nozzle). In this context the exterior surfaces of the sleeve include the ends of the sleeve and outer cylindrical surface. The inside cylindrical surface that the filament passes through is an interior rather than an exterior surface. One end of the sleeve interfaces with the mounting block and another end of the sleeve directly interfaces with a nozzle connected to the heater block. The sleeve has an inside diameter that has the same size or larger than an entry inside diameter of the nozzle so that there is a smooth transition for the filament into the nozzle. The abutment of the sleeve with the nozzle can be useful for a number of reasons including preventing leakage of the melted material out of the throat.

The system may also include a heater that is thermally connected to the heater block. A wide variety of heater types and geometries could be used. The cartridge heater illustrated is only one example. A thermal insulation block can be interposed between the mounting block and heater block to reduce heat flow between the heater block and the mounting block. The sleeve and fastener pass through the thermal insulation and into the mounting block. A filament of print material passes through an actively cooled zone in the mounting block, an insulated zone as the filament passes through the polymer sleeve, and a melt zone in the nozzle threaded into the heater block. The extrusion head may also include a thermistor bolt threaded into the heater block. The thermistor bolt includes a bolt body with a cavity, a thermistor placed in the cavity, and potting material surrounding the thermistor and filling the cavity. The mounting block can be sandwiched between a heat sink and a mounting surface of a drive motor. The heat sink and fan actively cool the mounting block. In one implementation, the head includes only one metallic thermally conductive path between the heater and the mounting block. The metallic thermally conducting path in one example may be the fastener that is offset from the filament path through the extrusion head.

In one example, a three dimensional printing system includes an extruder with an extrusion head made up of three connected blocks with each block having a different temperature during operation of the extrusion head. The system also includes a nozzle and an insulating sleeve passing through at least three connected blocks such that each exterior surface of the sleeve is in contact with surfaces of the three connected blocks or a nozzle. A feed mechanism accepts the filament of printing material and an actuator actuates the feed mechanism to pass the filament through the three connected blocks and insulating sleeve to the nozzle. An active cooling device is connected to one of the three connected blocks. The system includes a build platform and at least three controlled axes for moving the extruder relative to the build platform. Melted material is dispensed out of the nozzle to form the desired three dimensional object.

The three connected blocks may be pinned together by the insulating sleeve and joined by a fastener passing through two of the three connected blocks and threading into the third connected block. The fastener and the polymer sleeve may be parallel and offset to form a pin and fastener connection that prevents rotation of the heater block with respect to the mounting block such that the nozzle can be unthreaded from the heater block without the heater block spinning. In some implementations, a first block of the three blocks is a heater block; a second block of the three blocks is a thermally insulating block, and the third block of the three blocks is an actively cooled mounting block, in which the second block is the same planar geometry as the heater block and a heater is connected to the heater block. There may be an actively cooled zone in the mounting block, an insulated zone in the polymer sleeve, and a melt zone in the nozzle. The filament passes the actively cooled zone, the insulated zone, and the melt zone in the nozzle, in which the nozzle is threaded into the heater block and abuts an end of the polymer sleeve. A temperature sensor may be a thermistor bolt threaded into the heater block. The thermistor bolt includes a bolt body with a cavity, a thermistor placed in the cavity, and potting material surrounding the thermistor and filling the cavity. The connection between the heater block and the mounting block may be a fully constrained by a pin (the sleeve), bolt (the fastener), and plane connection.

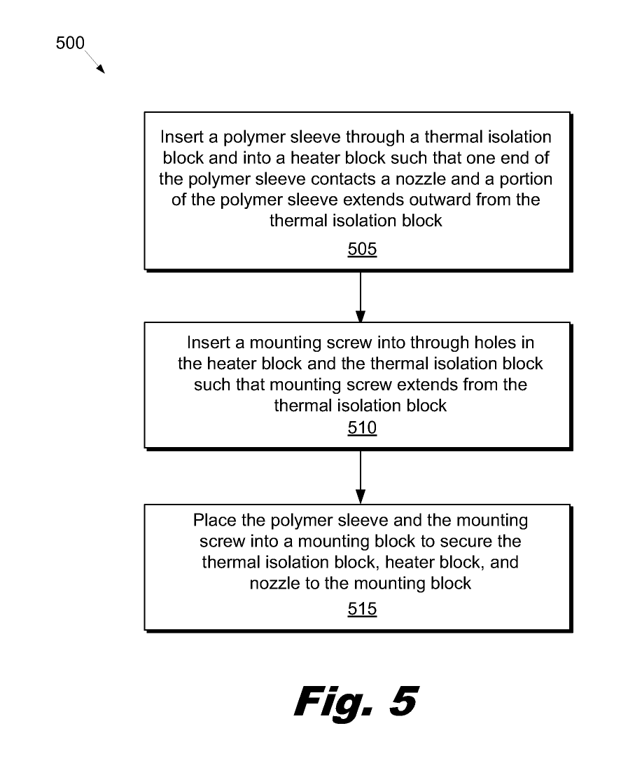

FIG. 5 is a flow chart of a method (500) for assembly and repair of an extrusion head on a three dimensional printer. The method includes inserting a polymer sleeve through a thermal isolation block and into a heater block such that one end of the polymer sleeve contacts a nozzle. A portion of the polymer sleeve extends outward from the thermal isolation block (step 505) when the end of the polymer sleeve is in contact with the nozzle. A mounting screw is inserted through holes in the heater block and the thermal isolation block such that the mounting screw extends from the thermal isolation block (step 510). In one example, the mounting screw and the polymer sleeve are parallel and laterally offset from each other.

The polymer sleeve and the mounting screw are placed into a mounting block to secure the thermal isolation block, heater block, and nozzle to the mounting block (step 515). In one example, the connection between the heater block and the mounting block is fully constrained such that the nozzle can be removed from the heater block without motion of the heater block with respect to the mounting block.

Operation of the three dimensional printer includes threading a filament into a tapered conic cavity in a mounting block and into an insulated zone formed by a polymer sleeve connecting the mounting block to the heater block and abutting the nozzle. The filament passes out of the polymer sleeve into a melt zone in the nozzle. The melted material is selectively ejected out of the nozzle as the nozzle is moved over the platform. The melted material solidifies to form the work piece on the platform.

The preceding description has been presented only to illustrate and describe examples of the principles described. This description is not intended to be exhaustive or to limit these principles to any precise form disclosed. Many modifications and variations are possible in light of the above teaching.

What is claimed is:

1. An extrusion head comprising:
a mounting block;
a heater block;
a polymer sleeve extending between the heater block and the mounting block; and
a fastener connecting the heater block to the mounting block;
wherein the polymer sleeve and the fastener create a fully constrained connection between the heater block and the mounting block.

2. The head of claim 1, wherein an exterior surface of the polymer sleeve is entirely enclosed.

3. The head of claim 1, wherein the polymer sleeve directly interfaces with a nozzle connected to the heater block.

4. The head of claim 1, wherein an end of the polymer sleeve directly abuts an entry of a nozzle.

5. The head of claim 1, wherein the fastener and the polymer sleeve are parallel and offset to form a pin and fastener connection that prevents rotation of the heater block with respect to the mounting block such that a nozzle can be unthreaded from the heater block without the heater block spinning.

6. The head of claim 1, further comprising:
a heater thermally connected to the heater block; and
a thermal insulation block interposed between the mounting block and the heater block to reduce heat flow between the heater block and the mounting block;
wherein the polymer sleeve and the fastener pass through the thermal insulation block and into the mounting block.

7. The head of claim 1, further comprising a filament of print material passing through an actively cooled zone in the mounting block, an insulated zone in the polymer sleeve, and a melt zone in a nozzle.

8. The head of claim 1, wherein a filament passing through the extrusion head passes through a conical taper and an actively cooled zone in the mounting block, an insulating zone as the filament passes through the polymer sleeve, and a melt zone in a nozzle threaded into the heater block and abutting an end of the polymer sleeve.

9. The head of claim 1, further comprising:
a heater mounted to the heater block; and
a thermistor bolt threaded into the heater block, the thermistor bolt comprising a bolt body with a cavity, a thermistor placed in the cavity, and potting material surrounding the thermistor and filling the cavity.

10. The head of claim 1, wherein the mounting block is sandwiched between a heat sink and a mounting surface of a drive motor.

11. The head of claim 1, wherein the head comprises only one metallic thermally conductive path between the heater block and the mounting block, wherein the metallic thermally conducting path comprises the fastener.

12. A system comprising:
an extruder comprising:
an extrusion head comprising:
three connected blocks, each block having a different temperature during operation of the extrusion head;
a nozzle; and
an insulating sleeve passing through at least the three connected blocks such that all exterior surfaces of the insulating sleeve are in contact with surfaces of the three connected blocks or the nozzle;
a feed mechanism to accept a filament of printing material;
an actuator to actuate the feed mechanism and pass the filament through the three connected blocks and the insulating sleeve to the nozzle;
an active cooling device connected to one of the three connected blocks;
a build platform; and
at least three controlled axes for moving the extruder relative to the build platform.

13. The system of claim 12, wherein the three connected blocks are pinned together by the insulating sleeve and joined by a fastener passing through two of the three connected blocks and threading into a third of the three connected blocks, wherein the fastener and the insulating sleeve are parallel and offset to form a pin and fastener connection that prevents rotation of the heater block with respect to a mounting block such that the nozzle can be unthreaded from the heater block without the heater block spinning.

14. The system of claim 12, wherein the insulating sleeve directly abuts an entry of the nozzle.

15. The system of claim 12, wherein a first block of the three blocks is a heater block; a second block of the three blocks is a thermally insulating block, and a third block of the three blocks is an actively cooled mounting block, in which the second block has the same planar geometry as the heater block and a heater is connected to the heater block.

16. The system of claim 15, further comprising an actively cooled zone in the mounting block, an insulated zone in the insulating sleeve, and a melt zone in the nozzle; wherein the filament passes through the actively cooled zone, the insulated zone, and the melt zone in the nozzle, in which the nozzle is threaded into the heater block and abuts an end of the polymer sleeve.

17. The system of claim 15, further comprising a thermistor bolt threaded into the heater block, the thermistor bolt comprising a bolt body with a cavity, a thermistor placed in the cavity, and potting material surrounding the thermistor and filling the cavity.

18. A method comprising:
inserting a polymer sleeve through a thermal isolation block and into a heater block such that one end of the polymer sleeve contacts a nozzle in the heater block and a portion of the polymer sleeve extends outward from the thermal isolation block;
inserting a mounting screw into through holes in the heater block and the thermal isolation block such that the mounting screw extends from the thermal isolation block; and
placing the polymer sleeve and the mounting screw into a mounting block to secure the thermal isolation block, the heater block, and the nozzle to the mounting block.

19. The method of claim 18, wherein placing the polymer sleeve and the mounting block into the mounting block comprises forming a connection between the heater block and the mounting block such that the nozzle can be removed from the heater block without motion of the heater block with respect to the mounting block.

20. The method of claim 18, further comprising threading a filament into a tapered conic cavity in the mounting block and into an insulated zone formed by the polymer sleeve connecting the mounting block to the heater block and abutting the nozzle, wherein the filament passes out of the polymer sleeve into a melt zone in the nozzle, such that melted material is selectively ejected out of the nozzle to form a work piece as the nozzle moves over a platform.
